(19) United States
(12) Patent Application Publication
(10) Pub. No.: US 2024/0337371 A1
(43) Pub. Date: Oct. 10, 2024

(54) METHOD AND APPARATUS FOR STANDALONE, SELF-CONTAINED, ILLUMINATED SIGNAGE WITH SMALL GEOMETRIES

(71) Applicant: Alpha Signs GmbH, Landsberg (DE)

(72) Inventors: Matthias Krusche, Landsberg (DE); Martin Gosling, Landsberg (DE)

(73) Assignee: Alpha Signs GmbH, Landsberg (DE)

(21) Appl. No.: 18/626,377

(22) Filed: Apr. 4, 2024

Related U.S. Application Data
(60) Provisional application No. 63/494,086, filed on Apr. 4, 2023.

(51) Int. Cl. F21V 23/00; F21V 15/01; F21Y 113/00; F21Y 115/10

(52) U.S. Cl. CPC F21V 23/001; F21V 15/01; F21V 23/003; F21Y 2113/00; F21Y 2115/10

(57) ABSTRACT

Provided is a standalone illuminated lighting system which may include a converter, a plurality of connecting wires, and a lighting unit. The lighting unit may further include a block and a light emitting diode (LED) chain disposed within the block, which LED chain may include individual light emitting diodes (LEDs). The individual LEDs may be wired in series respective to each other.

### I. BACKGROUND

### A. Field of the Invention

The present subject matter is directed to apparatuses and methods regarding signage lighting and lighting systems. More specifically, the present subject matter is directed to methods and apparatuses for a safer, more compact, and more energy efficient LED illuminated lighting system.

### B. Description of Related Art

Historically, signage for retail shops or other business premises has been illuminated using techniques such as traditional neon lighting and/or fluorescent tubes due to their improved efficiencies over incandescent lighting. With the advent of Light Emitting Diode (LED) technology, efficiency has been improved upon even further, significantly lowering production costs, and making LED technology the technology of choice for the illumination of signage.

A disadvantage of the use of LEDs in backlighting or illumination applications, is that the LED itself is a “point” light source, due to its small size. As such, to backlight or illuminate an object, the light from the point source needs to be dispersed, in order to spread the light emitted by the LED over a larger surface area. There are numerous ways to achieve this and several physical factors which must be considered to ensure a uniform light dispersion: light intensity from the LED, the viewing angle of light from the LED, the distance between the LED and the surface being illuminated, and the distance between LEDs (for a multi-LED backlighting application).

A second disadvantage of LEDs is that they are current driven rather than voltage driven. In this respect, careful consideration must be given on how to drive and illuminate LEDs. With advances in driver technology, there are today a plethora of drivers designed specifically to drive LEDs. These include standalone solutions in the form of an LED module consisting of a number of LEDs and driver circuitry. The term “driver circuitry” may be used as a generic term for circuitry that drives (controls) a component or some other circuit, often via regulating current flow. Such modules are easy to use and can be considered in and of itself as a type of voltage driven LED device. These types of LED modules are typically used today to illuminate signage.

When the dimensions of a self-illuminating signage element are reduced, it becomes increasingly difficult to use LEDs due to the above two disadvantages. The distances are too small to present a uniform illumination at the face of the element. The number of LEDs need to be increased significantly, and the dimensions of signage are not sufficient to build in LED modules effectively or efficiently. Also, when using modules, the module drivers themselves generate heat far above the minimal heat generated by individual LEDs, and the quantity of modules is excessively large (to present a uniform illumination across the face of the element). The increased number of modules also increases the overall power consumption of the signage element.

The disclosed invention solves the above problems by introducing an LED lighting system that is compact, without sacrificing signage illumination or energy efficiency. The disclosed system provides a unique arrangement and wiring of individual LEDs that can significantly reduce power and heat dissipation of the system. Safety features help to maintain system integrity for the current-driven LED system.

Overall, the invention described allows safer, more space efficient, and more energy efficient use of LED signage illumination in furtherance of the activities described above.

### II. SUMMARY

In accordance with one aspect of the present invention, a standalone illuminated lighting system including a converter and transformer, a plurality of electrical connecting wires, and a lighting unit. The lighting unit includes a block having an illuminated face and a backplane opposite the illuminated face and an LED chain disposed within the block. The electrical connecting wires connect the converter to the LED chain in the lighting unit. Additionally, each individual LED is connected in reverse-parallel with a corresponding Zener diode, and each of these such groups are wired in series with each other. The transformer may be either a component of the converter or a separate component. The converter and transformer may regulate the current and voltage for the plurality of light emitting diodes (LEDs) to provide a constant current flow and variable voltage to the light emitting diodes (LEDs), and the standalone illuminated lighting system is capable of drawing power from a single power source.

In accordance with another aspect of the present invention, the lighting system does not include a light emitting diode (LED) module or a light emitting diode (LED) driver. The electrical connecting wires can be up to 100 meters (328.084 feet) in length, and the lighting system may include two electrical connecting wires. The block can be a plastic material, which can be acrylic, and the LED chain further includes up to 300 individual LEDs. The converter may further include an electrical current monitoring system.

In accordance with another aspect of the present invention, the lighting unit can further include a lay-out channel cut within the plastic material block. The lay-out channel may include a plurality of geometric shapes, wherein the geometric shapes of the lay-out channel house light emitting diodes (LEDs) of the LED chain, which geometric shapes may be at least 16 millimeters (0.63 inches) in width and at least 30 millimeters (1.181 inches) in height. Further, the lay-out channel may be cut within the backplane of the block of the lighting unit. The LED chain may fitted within the lay-out channel, and a sealing potting compound applied to the LED chain and the lay-out channel to seal the LED chain to the lay-out channel.

In accordance with another aspect of the present invention, the illuminated lighting system converter steps up voltage from about 110 to 240 volts (V) to about 750 volts (V) and wherein the electrical current monitor shuts down electrical current in the event current rises above 26 milliamperes (mA). This may be accomplished by either a controller that cuts power to the LEDs if current exceeds 26 mA or some physical component, nonlimiting examples of which include a fuse, circuit breaker, or other component chosen according to sound engineering judgment, that opens if the current exceeds 26 mA.

In accordance with another aspect of the present invention, a method of illuminating signage elements, the steps involving first providing a standalone illuminated lighting system. The standalone illuminated lighting system may include a converter and transformer having an electrical current monitor that monitors current from the converter, a plurality of electrical connecting wires, and a lighting unit. The transformer may be either a component of the converter or a separate component. The lighting unit includes a block of plastic material, having an illuminated face, a backplane opposite the illuminated face, and a lay-out channel cut within the backplane, and an LED chain having a plurality of light emitting diodes (LEDs) wired in series. The LED chain may be fit inline within the lay-out channel of the plastic material block. Each individual LED may be connected in reverse-parallel with a corresponding Zener diode. The electrical connecting wires electrically connect the converter to the LED chain in the lighting unit. Further steps include connecting the converter to the LED chain in the lighting unit by connecting the electrical connecting wires to the converter and to the LED chain in the lighting unit, connecting the lighting system to an external voltage source—said external source providing an output voltage—and converting the output voltage, using the converter, to a converted voltage. Next steps include running a current flow, at the converted voltage, through the lighting system connecting wires, to the LED chain within the lighting unit and illuminating the illuminated face of the plastic material block. Finally, minimizing the current flow within the lighting system to a constant pre-defined threshold value and disengaging current flow if the current exceeds the threshold value detected by the converter electrical current monitor.

In accordance with another aspect of the present invention, the threshold value for the above method can be 26 mA, and the lighting system plastic material used in the method can be acrylic. The lighting unit provided can further include a lay-out channel cut within the backplane of the plastic material block and a sealing potting compound. The LED chain may be fitted within the lay-out, and the sealing compound can be applied to seal the LED chain into the lay-out channel. The LED chain provided may further include up to 300 individual LEDs. The LED chain provided may also be arranged within the plastic material in geometric shapes, and the geometric shapes are at least 16 millimeters (0.63 inches) in width and at least 30 millimeters (1.181 inches) in height. The provided electrical connecting wires may be up to 100 meters (328.084 feet) in length.

Still other benefits and advantages of the invention will become apparent to those skilled in the art to which it pertains upon a reading and understanding of the following detailed specification.

### III. BRIEF DESCRIPTION OF THE FIGURES

The above drawings form part of the disclosure and specification and are included to further demonstrate certain aspects of the invention, which aspects will be described in detail later in this specification. The invention may be better understood by reference to these drawings in conjunction with the detailed description.

FIG. 1 is a diagram of the illuminated lighting system.

FIG. 2 is a detailed wiring diagram of the lighting system electrical components.

FIG. 3 is a close view of the LED component symbol shown in the wiring diagram of FIG. 2.

### IV. Detailed Description

Referring now to the drawings, wherein the showings are for purposes of illustrating embodiments of the invention only and not for purposes of limiting the same, and wherein like reference numerals are understood to refer to like components, FIG. 1 shows a standalone illuminated lighting system 10 according to some embodiments of the present subject matter. The lighting system 10 may include a converter 12 for converting an incoming (house or building) voltage to a suitable voltage for the lighting system 10, a plurality of connecting electrical wires 14, and a lighting unit 16 having an LED chain 20. The converter 12 operates to regulate the current and voltage to match the needs of a given number of light emitting diodes within the LED chain 20. More particularly, the converter 12 functions as an electrical or electro-mechanical device for converting alternating current to direct current and vice versa. According to certain aspects of the present teaching, the converter 12 may also function as a transformer, i.e., an inductive electrical device having two magnetically coupled coils which changes the voltage of an alternating current. In a transformer, alternating current in one magnetic coil creates a changing magnetic field which induces a current in the second coil. Transformers may be used to step up or step down the voltage in the circuit allowing for the voltage in the second coil to be either higher or lower than the voltage that drives the first coil. According to other aspects of the present teaching, the converter and transformer may operate as separate components. Accordingly, when used herein, the term converter, encompasses an electro or electro-mechanical component that also includes or functions as a transformer and an electro or electro-mechanical component which does not include or function as a transformer. The converter 12 may be connected to an external power source to convert voltage, as described in detail below. In certain embodiments, the converter 12 may also include an electrical current monitor. The plurality of connecting electrical wires 14 include a first end and a second end. The first end of the connecting electrical wire is connected to the converter 12 and the second end of the connecting electrical wire is connected to the LED chain 20 in the lighting unit 16. (additional details concerning the lighting unit 16 and the LED chain 20 are provided below). According to certain aspects of the present teaching, two connecting electrical wires 14 extend from the converter 12 to the LED chain 20 in the lighting unit 16 and complete a circuit between the converter 12 and the LED chain 20. This allows for current to flow from a positive terminal on the converter 12 through a first connecting wire to the LED chain 20 and through a second connecting wire to a negative terminal on the converter 12. Thus, the converter 12 provides a constant current source to the LED chain 20. In providing this constant current source, the converter 12 steps up the voltage required to illuminate the LED chain and drive the lighting system. According to certain aspects of the present disclosure, the converter may step up the voltage supply from a house main supply, of 110 volts to 240 volts, to 750 volts. However, any voltage increase necessary and deemed suitable by a person of ordinary skill in the art for illuminating the LED chain and driving the lighting system is also contemplated. The converter is capable of outputting a constant current, irrespective of the load connected to the converter in a controlled manner. According to certain aspects of the present teaching, the output from the converter may be immediately turned off should the value of current exceed a pre-defined threshold. The electrical connecting wires, which may be up to 100 meters in length, are capable of withstanding the output voltage from the converter and the current required by the lighting system.

According to further aspects of the present teaching, the LEDs in the signage element draw a minimal current. For example, according to certain aspects of the present teaching, the lighting system requires a 25 mA or about a 25 mA constant current source which requires a 25 mA or about a 25 mA drive current. Due to the minimal current drawn by the LED chain or lighting system, electricity can pass greater distances to illuminate the LED chain or lighting chain with significantly less resistance. This allows the electrical connecting wires 14 from the converter to the LED chain 20 to be much greater in length compared to typical lighting systems. According to certain aspects of the present teaching, the connecting wires 14 may be up to 100 meters (328.084 feet) in length.

According to further aspects of the present teaching, the lighting system disclosed herein eliminates the need for utilizing an LED module or driver and driver circuitry to generate sufficient current to power the light emitting diodes in the LED chain. This is accomplished by connecting a large number of light emitting diodes (LED) in series. By connecting the light emitting diodes (LEDs) in series rather than in parallel for illumination purposes significant savings in power and heat dissipation can be achieved. For example, a lighting system of 300 LEDs having a forward voltage (Vf) of 2.5 V to activate and illuminate the LEDS and a forward current (If) across the LEDS from anode to cathode of 25 mA which are connected in parallel and driven from a constant 12 V source requires 7.5 Amperes drive current. This results in a corresponding power dissipation of 90 Watts. However, a similar lighting system of 300 identical LEDs connected in series with a 25 mA constant current source requires only a 25 mA drive current. This results in a corresponding power dissipation of 18.75 Watts, i.e., about 80% power savings compared to a similar system wherein the LEDs are connected in parallel. The resulting savings in heat dissipation in a LED lighting system connected in series compared to a LED lighting system connected in parallel is also of the same magnitude, i.e., about 80%. Thus, the lighting system disclosed herein includes embodiments which do not include an LED module or driver.

Eliminating the use of a LED module or driver from the lighting system by connecting the light emitting diodes in series provides several advantages. First, the size of the signage element may be significantly reduced. Without the use of LED modules and drivers, the space typically reserved for these components is no longer necessary. This additional space within the self-illuminating signage element allows for the signage element to accommodate additional light emitting diodes, increased spacing or adjustments to distances between light emitting diodes, easier adjustments to the viewing angle of light emitted from the LEDs and easier adjustments to the distance between the LEDs and the surface being illuminated to allow for uniform illumination. Another advantage of eliminating LED modules and drivers from the lighting system is that it avoids excessive power consumption by the lighting system and eliminates excessive heat that is generated by the LED modules and drivers. This allows for more efficient powering of the lighting system and can allow for improvements in light intensity emitted from the LEDs for achieving uniform illumination.

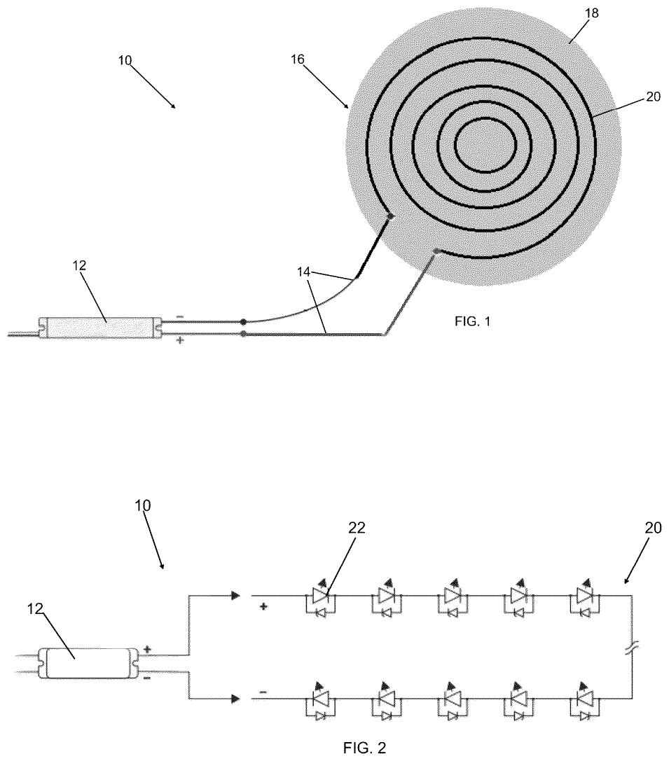

With reference now to FIGS. 1-2, the illuminating components may be included within the lighting unit 16. The lighting unit 16 may include a block of plastic material 18 having an illuminated face and a backplane disposed opposite the illuminated face, and an LED chain 20 disposed in line within the plastic material 18. In certain embodiments, the plastic material 18 may be acrylic. In some cases, the lighting unit 16 may be made exclusively of acrylic. The lighting unit 16 may include a chain of up to 300 LEDs which function to illuminate the lighting system uniformly. The lighting system may include forward pointing light emitting diodes (LEDs), does not include any hotspots and exhibits a minimal amount of heat dissipation. With reference to FIG. 2, the LED chain 20 may include individual LEDs 22. In some embodiments, the LED chain 20 may include up to 300 individual LEDs 22. The LEDs 22 may be electrically wired in series connection with each other. According to further aspects of the present teaching, each individual LED may be wired in reverse-parallel with a Zener diode as described below. The LED chain 20 may be arranged within the plastic material 18 within “intricate geometries,”, i.e., within geometric shapes which may be as narrow as 16 millimeters (0.63 inches) in width and as short as 30 millimeters (1.181 inches) in height. These “intricate geometries” or “geometric shapes” within the plastic material of the lighting unit 16 may be formed as a lay-out channel cut into the backplane (i.e., the back side or backplate) of the plastic material 18. The LEDs or LED chain inserted within the lay-out channel may then be sealed in place with an appropriate sealing potting compound deemed suitable to a person of ordinary skill in the art. This is accomplished by applying the potting compound to the lay-out channel and allowing the potting compound to cure, thereby providing a seal for the LED chain 20 within the plastic material 18.

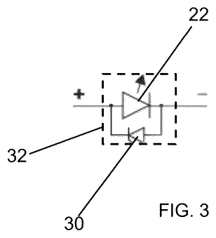

With reference to FIG. 3, each individual LED 22 within the LED chain 20 may be wired in reverse-parallel orientation 32 with a Zener diode 30. For systems wired in series, if a component in the series fails (here, an individual LED 22), the component will create an open circuit at that point, cease to allow flow of electrical current, and cause the entire series chain to fail as well. The Zener diode 30, when wired in reverse-parallel orientation 32, will not normally draw any electrical current from the LED 22 (i.e., the Zener diode 30 will function like an open circuit). However, if the Zener diode 30 experiences a great enough voltage, it will no longer be an open circuit, i.e., the circuit will close and will instead permit electrical flow across the diode. Diodes function like one-way valves for electrical current. Ordinarily, diodes will only allow electrical current to flow from the anode (positive end) to the cathode (negative end). A Zener diode, as in this aspect of the invention, allows current to flow from anode to cathode like an ordinary diode, but Zener diodes will allow current to flow from cathode to anode if the voltage across the Zener diode is above a certain threshold in the negative direction (if the voltage difference between the anode and cathode is great enough with the voltage at the cathode being greater than the voltage of the anode, current will flow through the Zener diode in the opposite direction). The wiring schema contemplated by this embodiment of the present disclosure creates a failsafe system, wherein if an individual LED 22 fails, the voltage that would have passed through the LED 22 will instead pass to the Zener diode 30. This will then cause the previously “open” circuit (the reverse-parallel 32 wired Zener diode 30) to close and permit flow across the Zener diode 30. Ultimately, the wiring system for the individual LEDs 22 and Zener diodes 30 in this embodiment allow the remainder of the individual LEDs 22 in the LED chain 20 to continue function, even if one individual LED 22 fails.

According to further aspects of the present teaching, the lighting system disclosed herein does not require the use of a voltage regulator, although a voltage regulator may be incorporated into the lighting system if deemed suitable by a person of ordinary skill in the art.

According to further aspects of the present teaching, the lighting system disclosed herein does not require the use of control wires that are electrically connected to the light emitting diodes (LEDs), although control wires may be incorporated into the lighting system if deemed suitable by a person of ordinary skill in the art.

According to further aspects of the present teaching, the lighting system is capable of operating with an alternating current (AC) voltage source in conjunction with an DC/AC converter or with direct current (DC) in conjunction with an AC/DC converter. According to other aspects of the present teaching, the lighting system is capable of converting direct current (DC) to an alternating current (AC) through a DC/AC converter to supply an alternating current (AC) voltage source to the lighting system. Alternatively, the lighting system is capable of converting alternating current (AC) to a direct current (DC) through an AC/DC converter to supply a direct current (DC) voltage source to the lighting system.

According to further aspects of the present teaching, the lighting system may be incorporated for use in internally illuminated signage.

The various components of the illuminated lighting system 10 operate to light up the plastic block illuminated face. The lighting system converter 12 may be wired to an external voltage source from a main supply. The main supply voltage may originate from a commercial, residential, or other voltage source. The converter 12 accepts the incoming voltage and steps the voltage received up or down (depending on the application) to a converted voltage. As current flows at the converted voltage, it passes through the lighting system electrical connecting wires 14, and into the lighting unit LED chain 20, illuminating the illuminated face of the plastic material block 18. According to certain aspects of the present teaching, the lighting system may include a converter electrical current monitor connected to or integrated within the converter. The converter electrical current monitor functions to monitor current flow within the lighting system 10 so that it is minimized to a constant pre-defined threshold value. The converter electrical current monitor may detect any change in current and may reduce or disengage current flow if the current exceeds the threshold value detected by the converter electrical current monitor. For example, according to certain aspects of the present teaching, if current rises above 26 mA, the converter electrical current monitor will detect the increased current, allowing the system to then shut down current flow to the LED chain 20.

Numerous embodiments have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

Having thus described the invention, it is now claimed:

What is claimed is:

1. A standalone illuminated lighting system comprising:
a converter and a transformer, wherein the transformer is either a component of the converter or a separate component;
a lighting unit comprising:
a block having an illuminated face and a backplane opposite the illuminated face;
a light emitting diode (LED) chain comprising a plurality of light emitting diodes (LEDs) connected in series disposed within the block;
wherein each individual LED is connected in reverse-parallel with a single corresponding Zener diode;
a plurality of electrical connecting wires, wherein the connecting wires electrically connect the converter to the LED chain in the lighting unit;
wherein the converter and transformer regulate the current and voltage for the plurality of light emitting diodes (LEDs) to provide a constant current flow and variable voltage to the light emitting diodes (LEDs); and
wherein the standalone illuminated lighting system is capable of drawing power from a single power source.

2. The standalone illuminated lighting system of claim 1, wherein the lighting system does not include a light emitting diode (LED) module or a light emitting diode (LED) driver.

3. The standalone illuminated lighting system of claim 1, comprising two electrical connecting wires.

4. The standalone illuminated lighting system of claim 1, wherein the connecting wires are up to 100 meters (328.084 feet) in length.

5. The standalone illuminated lighting system of claim 1 wherein the LED chain further comprises up to 300 individual LEDs.

6. The standalone illuminated lighting system of claim 1, wherein the block of the lighting unit comprises a plastic material.

7. The standalone illuminated lighting system of claim 6, wherein the lighting unit comprises a lay-out channel within the plastic material.

8. The standalone illuminated lighting system of claim 7, wherein the lay-out channel comprises a plurality of geometric shapes, wherein the geometric shapes of the lay-out channel house light emitting diodes (LEDs) of the LED chain.

9. The standalone illuminated lighting system of claim 8, wherein the geometric shapes of the lay-out channel are at least 16 millimeters (0.63 inches) in width and at least 30 millimeters (1.181 inches) in height.

10. The standalone illuminated lighting system of claim 8, wherein the lay-out channel is cut within the backplane of the block of the lighting unit.

11. The standalone illuminated lighting system of claim 10, wherein the plastic material is an acrylic.

12. The standalone illuminated lighting system of claim 11, wherein the LED chain is fitted within the lay-out channel and wherein a sealing potting compound is applied to the LED chain and the lay-out channel to seal the LED chain to the lay-out channel.

13. The standalone illuminated lighting system of claim 1, wherein the converter further comprises an electrical current monitor.

14. The standalone illuminated lighting system of claim 13, wherein the converter steps up voltage from about 110 to 240 volts (V) to about 750 volts (V) and wherein the electrical current monitor shuts down electrical current in the event current rises above 26 milliamperes (mA).

15. A method of illuminating signage, the method comprising the following steps:
providing a standalone illuminated lighting system comprising:
a converter and a transformer, wherein the transformer is either a component of the converter or a separate component;
an electrical current monitor, wherein the electrical current monitor monitors current from the converter;
a plurality of electrical connecting wires;
a lighting unit comprising:
an LED chain comprising a plurality of light emitting diodes (LEDs) wired in series;
a block of plastic material having an illuminated face, a backplane opposite the illuminated face and a lay-out channel cut within the backplane;
an LED chain fitted inline within the lay-out channel of the plastic material block;
wherein each individual LED is connected in reverse-parallel with a single corresponding Zener diode;
wherein the electrical connecting wires electrically connect the converter to the LED chain in the lighting unit;
connecting the converter to the LED chain in the lighting unit by connecting the electrical connecting wires to the converter and to the LED chain in the lighting unit;
connecting the lighting system to an external voltage source, said external source providing an output voltage;
converting the output voltage using the converter to a converted voltage;
running a current flow, at the converted voltage, through the lighting system connecting wires, and to the LED chain within the lighting unit;
illuminating the illuminated face of the plastic material block;
minimizing the current flow from the converter to a constant pre-defined threshold value; and
disengaging current flow if the current exceeds the threshold value detected by the converter electrical current monitor.

16. The method of claim 15 wherein the threshold value is 26 milliamperes (mA).

17. The method of claim 15 wherein the lighting system plastic material is acrylic.

18. The method of claim 15, wherein the lighting unit further comprises applying a sealing compound to the LED chain fitted within the lay-out channel to seal the LED chain into the lay-out channel.

19. The method of claim 15:
wherein the LED chain comprises up to 300 individual LEDs;
wherein the LED chain is arranged within the plastic material in geometric shapes; and
wherein the shapes are at least 16 millimeters (0.63 inches) in width and at least 30 millimeters (1.181 inches) in height.

20. The method of claim 15 comprising two electrical connecting wires, wherein the electrical connecting wires are up to 100 meters (328.084 feet) in length.
